(19) United States
(12) Patent Application Publication
(10) Pub. No.: US 2025/0208854 A1
(43) Pub. Date: Jun. 26, 2025

(54) ELECTRONIC CONTROL SYSTEM, DATA STRUCTURE OF SOFTWARE PACKAGE, AND COMPUTER PROGRAM

(71) Applicant: DENSO CORPORATION, Kariya-city (JP)

(72) Inventors: Tsugutoyo OSAKI, Tokyo (JP); Ryota MORI, Kariya-city (JP)

(21) Appl. No.: 18/989,501

(22) Filed: Dec. 20, 2024

(30) Foreign Application Priority Data
Dec. 25, 2023 (JP) 2023-218026

(51) Int. Cl. G06F 8/65; G06F 9/455

(52) U.S. Cl. CPC G06F 8/65; G06F 9/45558

(57) ABSTRACT

An electronic control system includes: an Update and Configuration Management (UCM) that has a function of rewriting software and runs on an operating system of a hypervisor; rewrite software having a function of rewriting software and operating outside the hypervisor; and an activation controller configured to activate the UCM and the rewrite software. When activation of the UCM fails, the activation controller activates the rewrite software, and causes the rewrite software to rewrite the hypervisor or the software on the hypervisor.

### CROSS REFERENCE TO RELATED APPLICATION

The present application claims the benefit of priority from Japanese Patent Application No. 2023-218026 filed on Dec. 25, 2023. The entire disclosure of the above application is incorporated herein by reference.

### TECHNICAL FIELD

The present disclosure relates to an electronic control system, a data structure of a software package, and a computer program.

### BACKGROUND

For example, with the diversification of vehicle control, such as automated driving control, the scale of application software installed in a vehicle electronic control system (hereinafter referred to as an ECU (Electronic Control Unit)) is increasing. Further, with the advent of new versions of improved functions, the number of opportunities to reprogram ECU software is increasing. Furthermore, a technique for connected cars has also spreads together with the progress of communication networks or the like. In view of these circumstances, a technology has been provided in which a server distributes update software to a vehicle device via OTA (Over The Air), and the vehicle device rewrites its software with update software received from the server.

With the introduction of SoC (System on a Chip) for in-vehicle use, a configuration is provided in which multiple applications are implemented on an operating system (hereinafter referred to as OS (Operating System)) of a hypervisor (hereinafter referred to as HV (HyperVisor). AUTOSAR (AUTomotive Open System ARchitecture), which is a standardization organization, has defined UCM (Update and Configuration Management) as a means of rewriting software. For example, UCM is also implemented as one of the applications on an OS of HV.

### SUMMARY

An electronic control system includes: an Update and Configuration Management (UCM) that has a function of rewriting software and runs on an operating system of a hypervisor; rewrite software having a function of rewriting software and operating outside the hypervisor; and an activation controller configured to activate the UCM and the rewrite software. When activation of the UCM fails, the activation controller activates the rewrite software, and causes the rewrite software to rewrite the hypervisor or the software on the hypervisor.

### BRIEF DESCRIPTION OF THE DRAWINGS

FIG. 1 is a functional block diagram showing an overall configuration according to an embodiment.

FIG. 2 is a functional block diagram of a CPU.

FIG. 3 is a flowchart.

### DETAILED DESCRIPTION

However, in a configuration in which the UCM is implemented on the OS of the HV, when the OS becomes corrupted and cannot start up due to a memory leak in an application other than the UCM, or when the UCM itself becomes corrupted, the UCM will no longer operate. As a result, there is no way to rewrite the software, making recovery impossible.

The present disclosure provides an electronic control system, a software package data structure, and a computer program capable of being appropriately restored even when UCM on the operating system of a hypervisor stops working.

According to a first example embodiment of the present disclosure, an electronic control system includes: an Update and Configuration Management (UCM) that has a function of rewriting software and runs on an operating system of a hypervisor; rewrite software having a function of rewriting software and operating outside the hypervisor; and an activation controller configured to activate the UCM and the rewrite software. When activation of the UCM fails, the activation controller activates the rewrite software, and causes the rewrite software to rewrite the hypervisor or the software on the hypervisor.

According to a second example embodiment of the present disclosure, a data structure of a software package is read and executed by an activation controller of an electronic control system including: an Update and Configuration Management (UCM) that has a function of rewriting software and runs on an operating system of a hypervisor; rewrite software having a function of rewriting software and operating outside the hypervisor; and an activation controller configured to activate the UCM and the rewrite software. When activation of the UCM fails, the activation controller activates the rewrite software, and causes the rewrite software to rewrite the hypervisor or the software on the hypervisor.

According to a third example embodiment of the present disclosure, a non-transitory computer-readable storage medium stores a computer program executed by a controller of an electronic control system including: an Update and Configuration Management (UCM) that has a function of rewriting software and runs on an operating system of a hypervisor; rewrite software having a function of rewriting software and operating outside the hypervisor; and an activation controller configured to activate the UCM and the rewrite software. The computer program causes the controller to: determine whether activation of the UCM is successful; and when determining that the activation of the UCM fails, activate the rewrite software and cause the rewrite software to rewrite the hypervisor or the software on the hypervisor.

According to the first to third example embodiments, when the activation of the UCM running on the operating system of the hypervisor fails, the rewrite software running outside the hypervisor is activated, and the rewrite software is caused to rewrite the hypervisor or the software on the hypervisor. Even when the UCM running on the operating system of the hypervisor fails to be activated and the UCM stops working, appropriate recovery can be achieved by starting the rewrite software that runs outside the hypervisor.

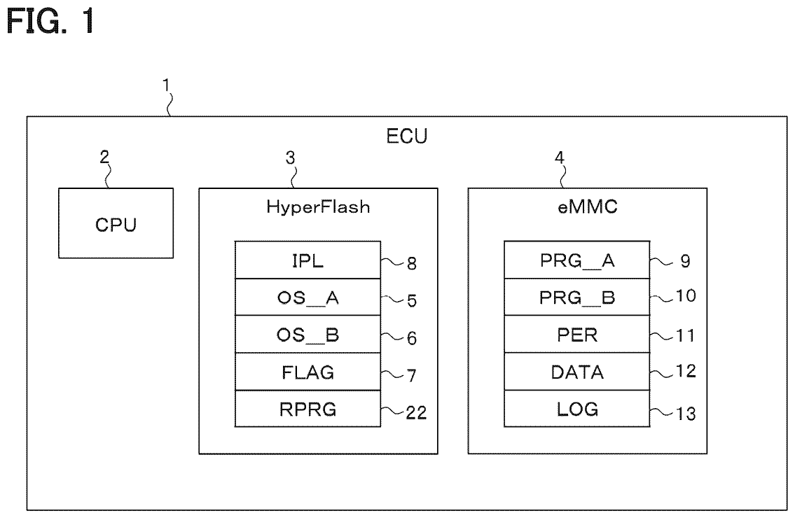

Hereinafter, an embodiment will be described with reference to the drawings. As shown in FIG. 1, an ECU 1 (corresponding to an electronic control system) mounted on a vehicle includes a CPU 2 (corresponding to a controller), a HyperFlash (registered trademark) 3, and an eMMC (embedded Mulch Media Card) 4. The HyperFlash 3 and the eMMC 4 are flash memories. The CPU 2 executes a computer program and controls the operation of the ECU 1.

The HyperFlash 3 and the eMMC 4 each have a two-bank configuration, with two banks having areas in which programs are written, which are referred to as a bank-A and a bank-B. In the HyperFlash 3, OS_A 5 is the bank-A in which software is written, and OS_B 6 is the bank-B in which software is written. A flag 7 is a boot flag that indicates whether a software boot bank is the bank-A or the bank-B. An IPL (Initial Program Loader) 8 (corresponding to a boot controller) reads the flag 7 to identify whether the boot bank is the bank-A or the bank-B, and boots either OS_A 5 or OS_B 6 according to the identification result.

In the eMMC 4, PRG_A9 is the bank-A in which application software is written, and PRG_B10 is the bank-B in which application software is written. The HyperFlash 3 and eMMC 4 are linked and the same bank is activated. That is, the bank-A of the HyperFlash 3 and the bank-A of the eMMC 4 are activated in conjunction with each other, and the bank-B of the HyperFlash 3 and the bank-B of the eMMC 4 are activated in conjunction with each other. Additionally, a PER 11 indicating a partition mode, data (DATA) 12, a log (LOG) 13, and the like are written in the eMMC 4.

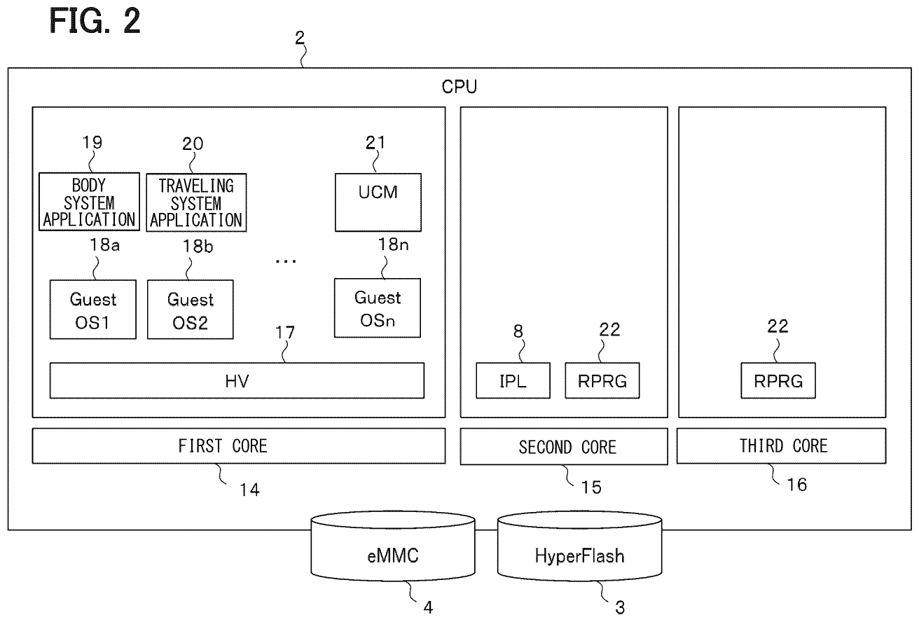

As shown in FIG. 2, the CPU 2 is a multi-core processor having multiple cores, namely, a first core 14, a second core 15, and a third core 16. The first core 14 has an HV 17 implemented therein, and multiple applications, such as a body system application 19 that controls the body system and a traveling system application 20 that controls the traveling system, are implemented on OSs 18a to 18n of the HV 17. The applications implemented on the OSs 18a to 18n of the HV 17 are not limited to the body system application 19 and the traveling system application 20. UCM 21 is also implemented as one of the applications on the OS 18a to 18n of the HV 17. The OSs 18a to 18n shown as GuestOS1 to OSn in FIG. 2 correspond to the OS_A 5 and OS_B 6 shown in FIG. 1.

The UCM 21 manages the entire process related to software updates, and acquires data packages related to software updates via a Data Communication Module (DCM) or a Data Link Connector (DLC) for wired communications. The UCM 21 notifies a flash writer (not shown) functioning as a memory controller of a write instruction or an erase instruction. Thereby, the flash writer writes or erases data in the HyperFlash 3 or the eMMC 4.

As described above, in a configuration in which the UCM 21 is implemented on OS 18a to 18n of the HV 17, when the OS 18a to 18n is corrupted and unable to be activated due to a memory leak in an application other than UCM 21, or when the UCM 21 itself is corrupted, the UCM 21 will no longer operate. As a result, there is no way to rewrite the software, and it is not possible to perform recovery. In this regard, in the present embodiment, as shown in FIG. 1, an RPRG 22 (corresponding to rewrite software) is implemented in the HyperFlash 3.

The RPRG 22 is activated by the second core 15 or the third core 16. That is, the RPRG 22 is rewrite software that operates outside the HV 17. The RPRG 22 has a configuration having some of the functions of the UCM 21, and the function of rewriting software is simpler than that of the UCM. The UCM 21 and the RPRG 22 can each be activated by an IPL 8. The RPRG 22 is activated by the IPL 8 when the activation of the UCM 21 fails. As a data structure of a software package that is read and executed by the IPL 8, when the activation of the UCM 21 fails, the RPRG 22 is activated and the HV 17 or the software on the HV 17 is rewritten by the RPRG 22.

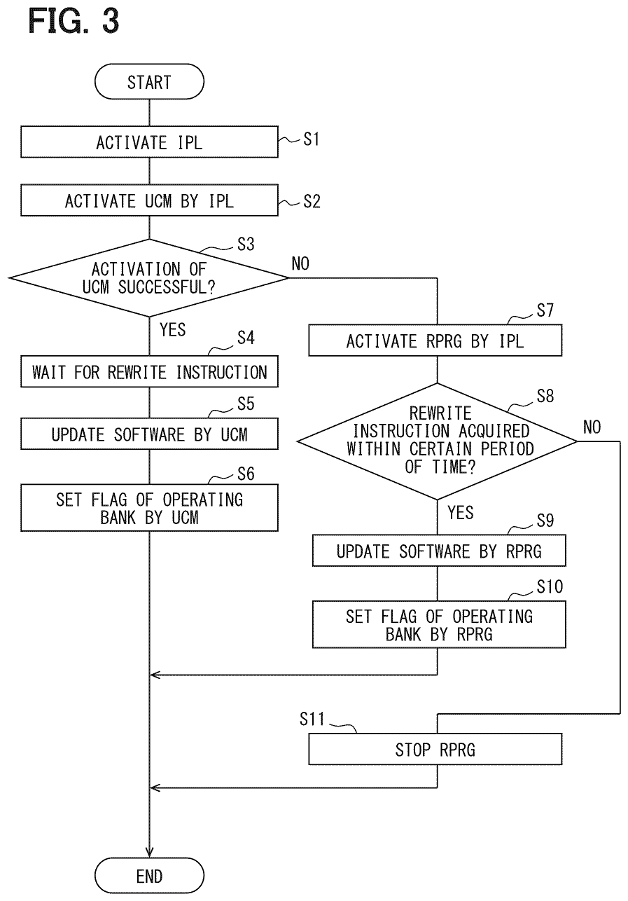

Next, an operation of the configuration described above will be described with reference to FIG. 3.

When the CPU 2 starts the rewrite process, it activates the IPL 8 (S1), and the IPL 8 activates the UCM 21 (S2). The CPU 2 determines whether the activation of the UCM 21 has been successful (S3, which corresponds to an activation success-failure determination process). When the CPU 2 determines that the activation of the UCM 21 has been successful (S3: YES), the CPU 2 waits for an external rewrite instruction (S4). When the CPU 2 receives the rewrite instruction from the outside, the CPU 2 updates the software using the UCM 21 (S5). When the CPU 2 completes updating the software by the UCM 21, the UCM 21 sets a flag for the operating bank (S6), and ends the rewrite process.

On the other hand, when the CPU 2 determines that the activation of the UCM 21 has failed (S3: NO), it activates the RPRG 22 by the IPL 8 (S7, which corresponds to a rewrite software activation process). The CPU 2 starts measuring time immediately after activation of the RPRG 22 and determines whether the rewrite instruction is received from the outside within a certain period from immediately after the activation of the RPRG 22 (S8). When the CPU 2 determines that the rewrite instruction has been received from the outside immediately after the activation of the RPRG 22 and before a certain period has elapsed, i.e., that the rewrite instruction has been received from the outside within the certain period (S8: YES), the CPU 2 updates the software by the RPRG 22 (S9). When the CPU 2 completes updating the software using the RPRG 22, the CPU 2 sets a flag for the operating bank using the RPRG 22 (S6), and ends the rewrite process. In this case, when the CPU 2 starts the rewrite process next time, the software update by the RPRG 22 has been completed, so that the CPU 2 activates the UCM 21 by the IPL 8.

On the other hand, when the CPU 2 determines that the certain period has elapsed immediately after the activation of the RPRG 22 before receiving the rewrite instruction from the outside, i.e., that no rewrite instruction has been received from the outside within the certain period (S8: NO), the CPU 2 stops the RPRG 22 (S11) and ends the rewrite process. Although the above describes an example in which software on the HV 17 is rewritten, the HV 17 may be rewritten.

As described above, according to the present embodiment, the following operation and effects can be obtained. In the ECU 1, when the activation of the UCM 21 operating on the OS 18a to 18n of the HV 17 fails, the RPRG 22 operating outside the HV 17 is activated, and the RPRG 22 executes rewriting of the HV 17 or the software on the HV 17. Even when the activation of the UCM 21 running on the OS 18a to 18n of the HV 17 fails and the UCM 21 stops working, it is possible to appropriately recover by activating the RPRG 22 running outside the HV 17.

The RPRG 22 operating outside the HV 17 is activated, and after the RPRG 22 has completed rewriting of the HV 17 or the software on the HV 17, the UCM 21 is activated. By starting the UCM 21, the UCM 21 can rewrite the HV 17 or the software on the HV 17.

When it is determined that no rewrite instruction is received from the outside within a certain period after the activation of the RPRG 22, the RPRG 22 is stopped. By stopping the RPRG 22, it is possible to appropriately end the rewrite process.

While the present disclosure has been described based on the above embodiment, the present disclosure is not limited to the embodiment or structures described herein. The present disclosure includes various modification examples and equivalents thereof. Furthermore, various combinations and formations, and other combinations and formations including one, more than one or less than one element may be included in the scope and the spirit of the present disclosure.

The controller and the method thereof described in the present disclosure may be implemented by a dedicated computer configured by a processor and a memory programmed to execute one or more functions embodied by a computer program. Alternatively, the controller and the method thereof described in the present disclosure may be implemented by a dedicated computer configured by a processor including one or more dedicated hardware logic circuits. Alternatively, the controller and the method thereof described in the present disclosure may be implemented by one or more dedicated computers configured by a combination of a processor and a memory programmed to execute one or more functions and a processor configured by one or more hardware logic circuits. The computer program may be stored in a computer-readable non-transitory tangible storage medium as an instruction to be executed by the computer.

What is claimed is:

1. An electronic control system comprising:
an Update and Configuration Management (UCM) that has a function of rewriting software and runs on an operating system of a hypervisor;
rewrite software having a function of rewriting software and configured to operate outside the hypervisor; and
an activation controller configured to activate the UCM and the rewrite software,
wherein
when activation of the UCM fails, the activation controller activates the rewrite software, and causes the rewrite software to rewrite the hypervisor or the software on the hypervisor.

2. The electronic control system according to claim 1, wherein
the activation controller activates the UCM after the rewrite software has completed rewriting the hypervisor or the software on the hypervisor.

3. The electronic control system according to claim 1, wherein
the activation controller stops the rewrite software when a rewrite instruction is not acquired within a certain period from the activation of the rewrite software.

4. The electronic control system according to claim 1, wherein
the rewrite software has a part of a function of the UCM.

5. A data structure of a software package read and executed by an activation controller of an electronic control system including:
an Update and Configuration Management (UCM) that has a function of rewriting software and runs on an operating system of a hypervisor;
rewrite software having a function of rewriting software and operating outside the hypervisor; and
the activation controller configured to activate the UCM and the rewrite software,
wherein
when activation of the UCM fails, the activation controller activates the rewrite software, and causes the rewrite software to rewrite the hypervisor or the software on the hypervisor.

6. A non-transitory computer-readable storage medium storing a computer program executed by a controller of an electronic control system including:
an Update and Configuration Management (UCM) that has a function of rewriting software and runs on an operating system of a hypervisor;
rewrite software having a function of rewriting software and operating outside the hypervisor; and
an activation controller configured to activate the UCM and the rewrite software,
wherein
the computer program causes the controller to:
determine whether activation of the UCM is successful; and
when determining that the activation of the UCM fails, activate the rewrite software and cause the rewrite software to rewrite the hypervisor or the software on the hypervisor.
